(19) United States
(12) Patent Application Publication
(10) Pub. No.: US 2020/0340599 A1
(43) Pub. Date: Oct. 29, 2020

(54) PRESSURE REDUCING VALVE

(71) Applicant: KOUW PINNQ ENTERPRISE CO., LTD., Taichung City (TW)

(72) Inventor: Fu-Chung Tsai, Taichung City (TW)

(21) Appl. No.: 16/391,765

(22) Filed: Apr. 23, 2019

(51) Int. Cl. F16K 47/04; F16K 17/04; F16K 17/24

(52) U.S. Cl. CPC F16K 47/04; F16K 17/24; F16K 17/048

(57) ABSTRACT

The present invention is a pressure reducing valve comprising a valve body and a piston. The interior of the valve body has a water inlet channel, a water outlet channel, a chamber between the water inlet channel and the water outlet channel, a wall separating the chamber and the water inlet channel, and a tube disposed at the wall and connecting the chamber to the water inlet channel. The piston is positioned inside the chamber and movable between an original position and a closed position. The piston only closes off the rear opening of the tube at the closed position, wherein the valve body is an integral structure and entirely made of the hard-plastic material. The piston has an integral structure made of TPE material. The rear opening of the tube is blocked when the piston is at the closed position.

### BACKGROUND OF INVENTION

### 1. Field of Invention

The present invention relates to components of the water purification system, especially the pressure reducing valves in this system.

### 2. Related Prior Art

In the existing water purifier system (e.g. reverse osmosis), external water typically flows through a pressure reducing valve of the system before entering the interior of the system. When the water pressure at the inlet end of the pressure reducing valve becomes higher than a preset value, a movable piston in the pressure reducing valve moves along with the change of the water pressure at the inlet end, so that the water volume flowing through the pressure reducing valve is changed, and even cutting off the water flow when the water pressure at the inlet end reaches the limit, so as to ensure that the water pressure at the outlet end of the pressure reducing valve will not be too high, which prevent the components in the system from being damaged by the excessive water pressure.

Such a pressure reducing valve is also known as a relief pressure valve or a control valve, and various designs have been available, for example, CN205350478U, CN205479563U, CN205383294U, CN203906927U, CN103411009B, and CN206093090U.

### SUMMARY OF INVENTION

The present invention offers a novel pressure reducing valve comprising a valve body, two connectors, an inner seal ring, a piston, a spring element, an outer seal ring and a restriction element. Specifically, the valve body has a water inlet channel, a water outlet channel, a chamber between the water inlet channel and the water outlet channel, a wall separating the chamber and the water inlet channel, and a tube disposed at the wall and connecting the chamber to the water inlet channel, wherein the valve body is an integral structure and entirely made of the hard-plastic material, and that the tube has a front opening toward the water inlet channel and a rear opening toward the chamber.

The two connectors are respectively fixed to the water inlet channel and the water outlet channel of the valve body to respectively connect to a water inlet pipe and to a water outlet pipe.

The piston is sleeved on the tube of the valve body and movable between an original position and a closed position, wherein the piston includes a tubular portion sleeved on the tube, a block that closes off the rear opening of the tube only at the closed position, and multiple connecting ribs separately and radially arranged around the periphery of the block. The two ends of each connecting rib are respectively connected to the tubular portion and the block, and a water flow passage is formed between every two connecting ribs, wherein the piston has an integral structure, and entirely made of TPE material, so that the block is elastic and softer than the tube.

The inner seal ring is sleeved on the tube of the valve body and positioned between the tube and the tubular portion of the piston. The outer seal ring is sleeved on the tubular portion of the piston and positioned between the tubular portion and the valve body.

The spring element is positioned in the chamber of the valve body and resisting the movement of the piston towards the wall with its elastic force. The restriction element is fixed in the valve body for blocking the piston, wherein the restriction element has a through hole connecting the chamber to the water outlet channel.

In an embodiment, the piston of the present invention described above is made of a thermoplastic vulcanized.

In an embodiment, the block of the piston of the present invention described above is partially positioned within the tubular portion and partially outside the tubular portion. Preferably, the radially arranged connecting ribs of the piston described above form a receiving space receiving a portion of the tube of the valve body.

In an embodiment, the restriction element of the present invention described above has multiple protrusions separately and radially arranged around the periphery of the through hole. The protrusions lay against the tubular body of the piston.

In an embodiment, the tube of the present invention described above has a front portion and a rear portion whose outer diameter is smaller than the front portion, so that the junction between the front portion and the rear portion forms a first annular shoulder, the inner seal ring sleeved on the rear portion and against the first annular shoulder. Preferably, the inner diameter of the water outlet channel of the present invention described above is larger than the chamber, so that the junction between the water outlet channel and the chamber forms a second annular shoulder, and the restriction element is positioned inside the chamber and has an annular block laying against the second annular shoulder. More preferably, the valve body has an annular protrusion disposed within the valve body adjacent to the second annular shoulder and extending inwardly with two slopes meeting along an apex, the annular protrusion surrounding the water outlet channel and against the annular block of the restriction element. Moreover, the connector of the water outlet channel of the present invention described above is fixed to the valve body presses the annular block of the restriction element.

The present invention provides a different type of pressure reducing valve, which has few components and is easy to assemble. In particular, it has the piston made of TPE material described above and an integral-structure valve body.

### BRIEF DESCRIPTION OF DRAWINGS

The invention is illustrated by the accompanying drawings in which corresponding parts are identified by the same numerals and in which:

FIG. 1 is an exploded perspective view of a pressure reducing valve in accordance with the preferred embodiment of the invention;

FIG. 2 is another exploded perspective view of a pressure reducing valve in accordance with the preferred embodiment of the invention;

FIG. 3 is perspective view of a pressure reducing valve in accordance with the preferred embodiment of the invention;

FIG. 4 is a cross-sectional view of the preferred embodiment of the present invention showing the piston in an original position;

FIG. 5 is a cross-sectional view of the preferred embodiment of the present invention showing the piston in a closed position;

### DETAILED DESCRIPTION OF PREFERRED EMBODIMENT

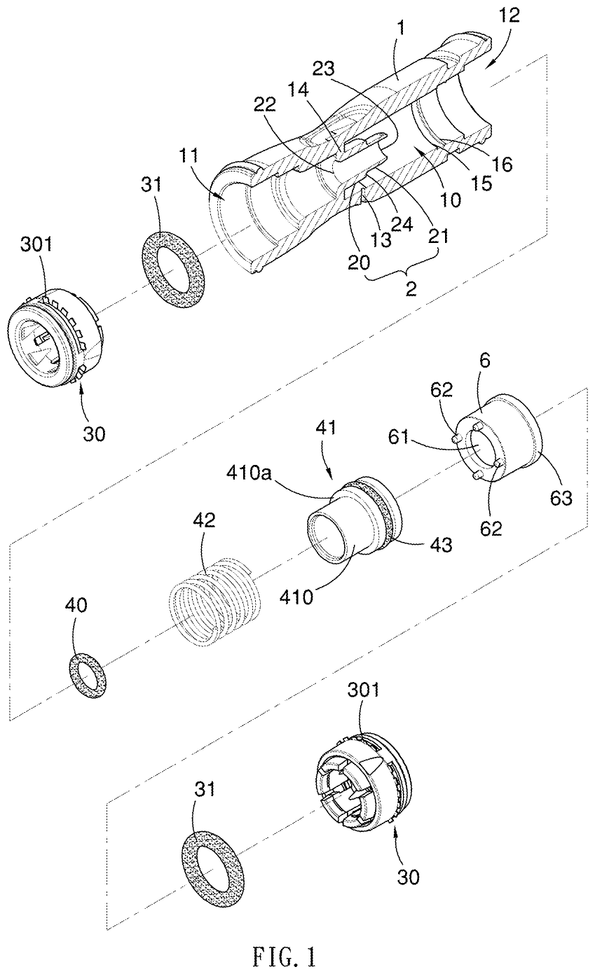

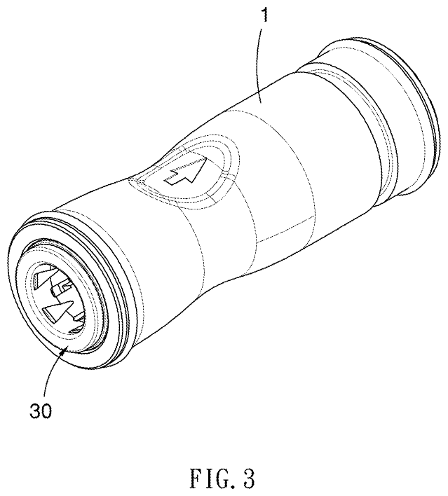

Referring now to FIGS. 1 through 3 of the drawings, the pressure reducing valve of the present invention includes a valve body 1, two connectors 30 disposed in the valve body 1, two seal rings 31, an inner seal ring 40, a piston 41, a spring element 42, an outer seal ring 43, and a restriction element 6, but this is only a preferred embodiment for the purpose of illustrating the present invention, and does not indicate that the foregoing elements are the essential elements of the present invention.

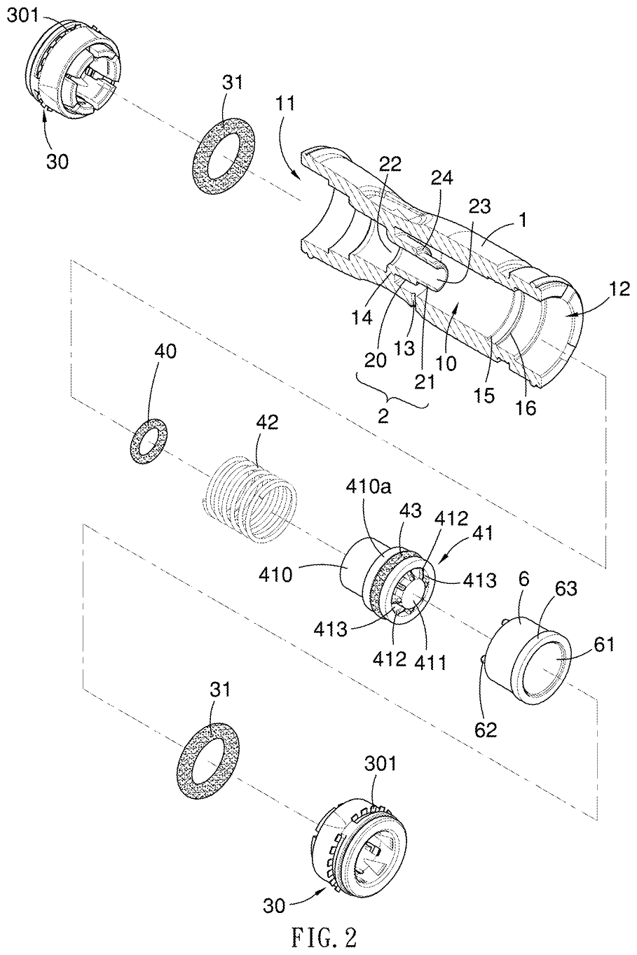

As shown in FIGS. 1 and 2, the valve body 1 has a water inlet channel 11, a water outlet channel 12, a chamber 10 between the water inlet channel 11 and the water outlet channel 12, a wall 14 for separating the chamber 10 and the water inlet channel 11, and a tube 2 disposed on the wall 14 and connecting the chamber 10 to the water inlet channel 11. The tube 2 has a front portion 22 towards the water inlet channel 11 and a rear portion 23 towards the chamber 10, wherein the valve body 1 has an integral structure and entirely made of the plastic material, for example, polyoxymethylene (POM) material or of other hard materials such as a metal material.

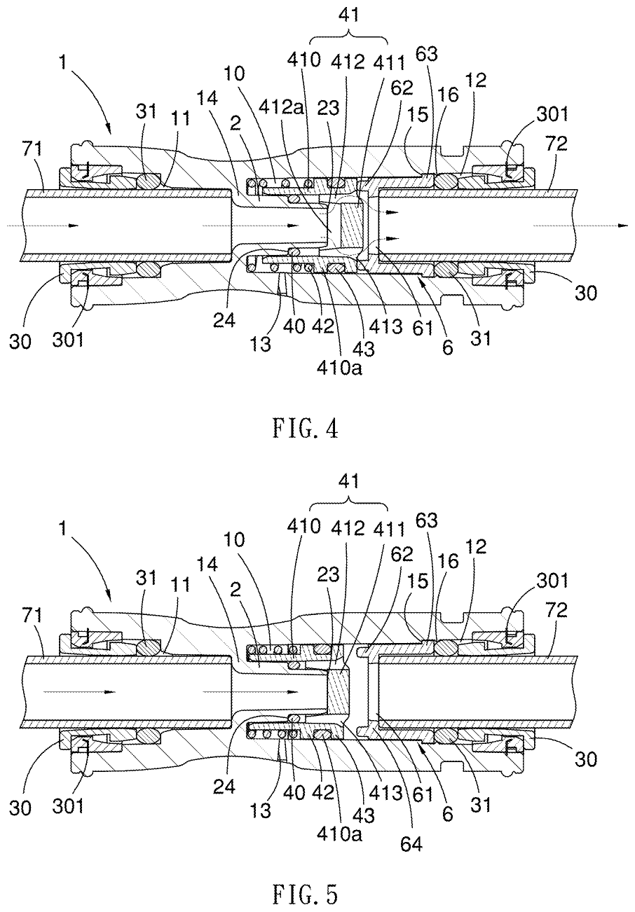

The two connectors 30 are respectively fixed in the water inlet channel 11 and in the water outlet channel 12 of the valve body 1. Each of the connectors 30 may be a quick connector with a mating seal ring, such as US20030160451A1, or a conventional pipe fitting. In this embodiment, each of the connectors 30 is a quick connector and has clip ring 301 made of the elastic metal, multiple teeth forming on the outer periphery of each clip ring 301. As shown in FIG. 4, each of the connectors 30 is respectively inserted into the water inlet channel 11 and the water outlet channel 12 of the valve body 1 and fastened by the clip ring 301, and is respectively connected to an inlet pipe 71 and an outlet pipe 72 with the seal ring 3, wherein the inlet pipe 71 is connected to an external water source (not shown in FIG. 4), such as a faucet, and that the outlet pipe 72 is connected to a water treatment device (not shown in FIG. 4), such as a reverse osmosis device, so that the water of the external water enters the valve body 1 through the inlet pipe 71 and flows into the water treatment device through the outlet pipe 72.

The piston 41 is sleeved on the tube 2 of the valve body 1 and movable between an original position shown in FIG. 4 and a closed position shown in FIG. 5. As shown in FIGS. 1 and 2, the piston 41 includes a tubular portion 410 sleeved on the tube 2, a block 411 only closing off the rear port 23 of the tube 2 at the closed position, and multiple connecting ribs 412 separately and radially arranged around the periphery of the block 411, the two ends of each connecting rib 412 are respectively connected to the tubular portion 410 and the block 411, and a water flow passage 413 formed between every two connecting ribs 412, wherein the piston 41 has an integral structure, and entirely made of TPE material, so that the tubular portion 410, the block 411, and the multiple connecting ribs 412 are made of TPE material, and that the block 411 is elastic and softer than the tube 2;

In this embodiment, the TPE material may be the thermoplastic vulcanizate (TPV), but is not limited to this. The thermoplastic vulcanizate has the properties both of rubber and of plastic, so that the piston 41 has a structural strength strong enough to maintain its shape without being distorted, and the block 411 is elastic and soft enough to provide a good seal at the closed position.

As shown in FIG. 4, the block 411 of the piston 41 is partially positioned within the tubular portion 410 and partially outside the tubular portion 410. Alternatively, the block 411 may be entirely positioned inside the tubular portion 410 or entirely positioned outside the tubular portion 410. Moreover, although it is not necessary, the connecting ribs 412 of the piston 41 may be radially arranged to form a receiving space 412a, and the receiving space 412a may receive a portion of the tube 2 of the valve body 1.

The inner seal ring 40 is sleeved on the tube 2 of the valve body 1 and positioned between the tube 2 and the tubular portion 410 of the piston 41. The outer seal ring 43 is sleeved on the tubular portion 410 of the piston 41 and positioned between the tubular portion 410 and the valve body 1.

The spring element 42 is positioned in the chamber 1 of the valve body 10 and resisting the movement of the piston 41 towards the wall 14 with its elastic force. The spring element 42 is a compression spring sleeved on the tubular portion 410 of the piston 41, and the two ends of the compression spring respectively lay against the wall 14 of the valve body 1 and an annular flange 410a on the tubular portion 410, wherein the compression spring is not the only choice of the spring element 42, that other forms of spring or elastomer may be selected.

As shown in FIGS. 1 and 2, the restriction element 6 has a through hole 61. As shown in FIG. 4, the through hole 61 connects the chamber 10 to the water outlet channel 12, the restriction element 6 is fixed in the valve body 1 for blocking the piston 41 so that the piston 41 can only move within the chamber 10 and cannot get out of the chamber 10. Further, the restriction element 6 preferably has multiple protrusions 62 separately and radially arranged around the periphery of the through hole 61. In this embodiment, the protrusions 62 lay against the tubular portion 410 of the piston 41, so that the piston 41 is blocked, but the projections 62 are not necessary and may be optionally removed.

As shown in FIGS. 1 and 2, the tube 2 has a front portion 20 and a rear portion 21 whose outer diameter is smaller than the front portion 20, so that a first annular shoulder 24 is formed at the junction between the front portion 20 and the rear portion 21. As shown in FIG. 4, the inner seal ring 40 is sleeved on the rear portion 21 and against the first annular shoulder 24. However, the structure of the tube 2 is not limited to the foregoing description, and for example, the entire tube may have the same outer diameter.

Additionally, although not necessary, as shown in FIG. 4, the inner diameter of the water outlet channel 12 of the valve body 1 is larger than the chamber 10, so that a second annular shoulder 15 is formed at the junction between the water outlet channel 12 and the chamber 10. The restriction element 6 is inserted into the chamber 10 and has an annular block 63 against the second annular shoulder 15.

Preferably, the annular block 63 of the restriction element 6 can be pressed by one of the connectors 30 and its seal ring 31, so that the restriction element 6 is fixed at that position, wherein the annular block 63 of the restriction element 6 is indirectly pressed by the one of the connectors 30 in the foregoing description, and that if the seal ring 31 is not used, one of the connectors 30 can directly press on the annular block 63. In other words, the connector 30 of the water outlet channel 12 fixed to the valve body 2 presses on the annular block 63 of the restriction element 6.

As shown in FIGS. 1 and 2, although not necessary, the valve body 1 may have an annular protrusion 16. The annular protrusion 16 surrounds the water outlet channel 12 and is adjacent to the second annular shoulder 15. As shown in FIG. 4, the annular protrusion 16 also blocks the annular block 63 of the restriction element 6. Since the annular block 63 is low, it does not prevent the restriction member 6 from being inserted into the chamber 10.

The pressure reducing valve of the present invention in a normal state is as shown in FIG. 4. The piston 41 is pushed back against the restriction element 6 by the elastic force of the spring element 42. At the same time, the block 411 of the piston 41 is located at the original position, that is, the open position, so that the water from the external water source flowing into the inlet pipe 71 can flow through the water inlet channel 11 of the valve body 1. And then, through the tube 2 and through the water flow passage 413 of the piston 41, the water flows towards the water outlet channel 12 of the valve body 1 and flows into the water treatment device via the outlet pipe 72.

When the water pressure of the water inlet channel 11 of the valve body 1 is higher than a preset pressure (the preset pressure is determined by the elastic force of the spring element 42), the water pressure in the chamber 10 will also be higher than the preset pressure. At the same time, the piston 41 is moved forward by the reverse thrust generated by the water pressure in the chamber 10, that is, moved toward the wall 14 and the spring element 42 is consequently compressed, so that the gap between the block 411 and the rear opening 23 of the tube 2 becomes smaller, or the water flow passage 413 becomes smaller, which makes the water flow lower and the pressure in the chamber 10 decrease. At the same time, the reverse thrust on the piston 41 is correspondingly reduced, so that the piston 41 can be moved backward by the elastic force of the spring element 42, that is, moved toward the restriction element 6 in order to make the water flow higher.

If the water pressure of the water inlet channel 11 is higher than the preset pressure, which makes the water pressure in the chamber 10 equal to or higher than an upper limit value, the piston 41 will receive a greater reverse thrust and be pushed forward to the closed position, as shown in FIG. 5. At the same time, the block 411 blocks the rear opening 23 of the tube 2 in order to prevent the water from flowing to the water outlet channel 12 of the valve body 1. However, if the water pressure is lower than the upper limit value, the piston 41 will be pushed backward by the elastic force of the spring element 42, so that the block 411 no longer blocks the rear opening 23 of the tube 2, which allows the water to flow towards the water outlet channel 12. Once the water pressure in the chamber 10 is equal to or lower than the preset pressure, the piston 41 will return to the original position as shown in FIG. 4.

Preferably, a vent hole 13 may be set on the valve body 1. The vent hole 13 connects the space in which the spring element 42 is located to the external space.

In summary, the pressure reducing valve of the present invention is fully utilized by the industry. Its implementation method has been clearly and fully disclosed in the above embodiments. It will be appreciated that the scope of this invention is to be defined by the appended claims.

1. A pressure reducing valve comprising:
a valve body having a water inlet channel, a water outlet channel, a chamber between the water inlet channel and the water outlet channel, a wall separating the chamber and the water inlet channel, and a tube disposed at the wall and connecting the chamber to the water inlet channel, wherein the valve body is an integral structure and entirely made of hard-plastic material;
the tube having a front opening toward the water inlet channel and a rear opening toward the chamber;
two connectors respectively fixed to the water inlet channel and the water outlet channel of the valve body to respectively connect to a water inlet pipe and to a water outlet pipe;
a piston is sleeved on the tube of the valve body and movable between an original position and a closed position, wherein the piston includes a tubular portion sleeved on the tube, a block only closing off the rear opening of the tube at the closed position, and multiple connecting ribs separately and radially arranged around the periphery of the block, the two ends of each connecting rib respectively connected to the tubular portion and the block, and a water flow passage formed between every two connecting ribs, wherein the piston has an integral structure, and entirely made of TPE material, so that the block is elastic and softer than the tube;
an inner seal ring sleeved on the tube of the valve body and positioned between the tube and the tubular portion of the piston;
an outer seal ring sleeved on the tubular portion of the piston and positioned between the tubular portion and the valve body;
a spring element positioned in the chamber of the valve body and resisting the movement of the piston towards the wall with its elastic force; and
a restriction element fixed in the valve body for blocking the piston, wherein the restriction element has a through hole connecting the chamber to the water outlet channel.

2. The pressure reducing valve according to claim 1, wherein the piston is made of a thermoplastic vulcanized.

3. The pressure reducing valve according to claim 1, wherein the block of the piston is partially positioned within the tubular portion and partially outside the tubular portion.

4. The pressure reducing valve according to claim 3, wherein the radially arranged connecting ribs of the piston form a receiving space receiving a portion of the tube of the valve body.

5. The pressure reducing valve according to claim 1, wherein the restriction element has multiple protrusions separately and radially arranged around the periphery of the through hole, the protrusions laying against the tubular body of the piston.

6. The pressure reducing valve according to claim 1, wherein the tube has a front portion and a rear portion whose outer diameter is smaller than the front portion, so that the junction between the front portion and the rear portion forms a first annular shoulder, the inner seal ring sleeved on the rear portion and against the first annular shoulder.

7. The pressure reducing valve according to claim 6, wherein an inner diameter of the water outlet channel is larger than the chamber, so that the junction of the water outlet channel and the chamber forms a second annular shoulder, the restriction element positioned inside the chamber and having an annular block laying against the second annular shoulder.

8. The pressure reducing valve according to claim 7, wherein the valve body has an annular protrusion disposed within the valve body adjacent to the second annular shoulder and extending inwardly with two slopes meeting along an apex, the annular protrusion surrounding the water outlet channel and against the annular block of the restriction element.

9. The pressure reducing valve according to claim 7, wherein the connector of the water outlet channel fixed to the valve body presses the annular block of the restriction element.
